(19) United States
(12) Patent Application Publication
(10) Pub. No.: US 2011/0068668 A1
(43) Pub. Date: Mar. 24, 2011

(54) Cabinet assembly and method

(76) Inventor: Michael Crosbie Wilson, Glen Ellyn, IL (US)

(21) Appl. No.: 12/586,592

(22) Filed: Sep. 24, 2009

(51) Int. Cl. A47B 47/00; B23P 11/00

(52) U.S. Cl. 312/265.5; 29/428

(57) ABSTRACT

An improved cabinet assembly includes a plurality of wall panels and at least two generally rectangular horizontal support members to define a parallelepiped configuration. The cabinet comprises a plurality of elongate corner posts, at least one for each corner of the parallelepiped configuration. The corner posts selectively support the wall panels in the parallelepiped configuration. Each corner post has a rectangular through bore extending a length of the corner post. Each of the at least two horizontal support members include rectangular through bores aligned with the corner post through bores at each corner of the parallelepiped configuration. A plurality of rectangular splines are provided, one for each corner of the parallelepiped configuration. Each of the splines is received in the aligned rectangular through bores at one of the corners of the parallelepiped configuration to maintain the cabinet assembly in assembled relationship.

### CROSS REFERENCE TO RELATED APPLICATIONS

There are no related applications.

### FIELD OF THE INVENTION

The present application relates to cabinets and, more particularly, to a drop down cabinet assembly and method.

### BACKGROUND OF THE INVENTION

A cabinet in its basic form comprises a piece of furniture fixed in place in a home or the like. Cabinets are most commonly used in a kitchen, bathroom or other portions of a home where storage is desired. A cabinet consists of a case with a front, back, opposite sides, a top and a bottom in a parallelepiped configuration. The cabinet may include shelves or drawers or doors or combinations thereof, as necessary or desired.

A typical cabinet, such as a kitchen cabinet, uses box or frame construction typically made of plywood or particle board, or the like. The cabinet is constructed using opposite side or end panels, a bottom panel and a back panel secured together using glue, nails, screws, or combinations thereof. Facers are typically secured around the front of the cabinet to provide access to the cabinet. A countertop is typically mounted atop the cabinet.

Such cabinets may be provided in standard sizes and configuration or custom design. The cabinets are typically constructed in a factory and then shipped to a user for installation. Each cabinet must be boxed or somehow protected during shipment and can be expensive to ship due to the size and weight of individual cabinets.

At a job site, it is necessary to install the cabinets one at a time using a building block approach. Each cabinet must be shimmed for leveling and alignment with adjacent cabinets. The cabinets are then fastened together, such as with screws through the facers of adjacent cabinets. The cabinet is then fastened to the wall. This process continues until all of the cabinets are installed.

With such basic cabinet construction, the cabinets are constructed ahead of time and then shipped to the job site for installation. As discussed, this can result in expensive shipping costs and possibility of damage to the cabinet. Also, the design constraints require limited configurations for standard cabinet designs or require substantially more expensive custom cabinet designs. Each cabinet is manufactured as a distinct unit which is then married to adjacent cabinets at a job site resulting in seams between screwed together box cabinets. Also, the use of the box and frame cabinets have structural limitations with respect to use of heavy components such as sinks and the like which sometimes are supported directly by the cabinet, rather than by a countertop. Finally, during installation, the shimming of the cabinet can be quite difficult as the shimming is done to the panels themselves or requires the use of separate shims which can cause unseemly gaps.

The present invention is directed to an improved cabinet assembly and method.

### SUMMARY OF THE INVENTION

In accordance with the invention, there is provided a stacking and interlocking, building block system for constructing cabinets. The cabinet assembly and method provides the purchaser with an historic sense of craftsmanship and quality with a design that assembles quickly and securely with no glue, screws or other fasteners.

In accordance with one aspect of the invention, there is disclosed an improvement in a cabinet assembly including a plurality of wall panels and at least two generally rectangular horizontal support members to define a parallelepiped configuration. The improvement comprises a plurality of elongate corner posts, at least one for each corner of the parallelepiped configuration. The corner posts selectively support the wall panels in the parallelepiped configuration. Each corner post has a rectangular through bore extending a length of the corner post. Each of the at least two horizontal support members include rectangular through bores aligned with the corner post through bores at each corner of the parallelepiped configuration. A plurality of rectangular splines are provided, one for each corner of the parallelepiped configuration. Each of the splines is received in the aligned rectangular through bores at one of the corners of the parallelepiped configuration to maintain the cabinet assembly in assembled relationship.

It is a feature of the invention that select ones of the corner posts include an elongate dado receiving edges of the wall panels to support the panels in the parallelepiped configuration.

It is another feature of the invention that the horizontal support members include facing blind bores adjacent a front edge thereof and further comprising a door including a dowel pin extending from above and below the door and receivable in the facing bores to hingedly mount the door to the cabinet assembly. The door may comprise a rectangular panel including a dowel rod secured to a front face of the panel adjacent a side edge, with opposite ends of the dowel rod defining the dowel pins.

It is another feature of the invention that each cabinet post is segmented and a lower segment of each corner post is positioned below a lowermost of the horizontal support members to define a foot for resting on a support surface.

It is another feature of the invention to provide a plurality of pins each extending through a transverse opening at one of a top or bottom end of each spline.

It is an additional feature of the invention that at least one of the horizontal support members comprises a front stretcher and a rear stretcher and the rectangular through bores are located at ends of the stretchers. A shelf may be received on the front and rear stretchers of the at least one horizontal support members. The at least one of the horizontal support members may further comprise opposite side stretchers having rectangular through bores located at ends of the side stretchers for receiving the splines. The side stretchers rest atop the shelf and front and rear stretchers to retain the shelf in place.

It is an additional feature of the invention to provide a plurality of elongate center posts. The center posts selectively support wall panels in vertical planes between opposite ends of the parallelepiped configuration. Each center post has a rectangular through bore extending a length of the center post and aligned with corresponding aligned rectangular through bores and the horizontal support members for receiving a rectangular spline to maintain the cabinet assembly in assembled relationship to define plural cabinet segments sharing the center post.

There is disclosed in accordance with another aspect of the invention, the method of assembling a cabinet including a plurality of wall panels and at least two generally rectangular horizontal support members to define a parallelepiped configuration, comprising: providing a plurality of elongate corner posts, at least one for each corner of the parallelepiped configuration, the corner posts selectively supporting the wall panels in the parallelepiped configuration, each corner post having a rectangular through bore extending a length of the corner post; providing rectangular through bores in each of said at least two horizontal support members aligned with the corner post through bores at each corner of the parallelepiped configuration; providing a plurality of rectangular splines, one for each corner of the parallelepiped configuration; and sequentially mounting the corner posts and the horizontal support members to the rectangular splines so that each of the splines is received in the aligned rectangular through bores at one of the corners of the parallelepiped configuration to maintain the cabinet assembly in assembled relationship.

Further features and advantages of the invention will be readily apparent from the specification and from the drawings.

### BRIEF DESCRIPTION OF THE DRAWINGS

FIG. 1 is a perspective view of a sink base cabinet in accordance with the invention;

FIG. 2 is an exploded view of the sink base cabinet of FIG. 1 illustrating a method of assembly thereof;

FIG. 3 is a sectional view taken along the line 3-3 of FIG. 1;

FIG. 4 is a partial, cut away view, illustrating mounting of a shelf in the sink base cabinet of FIG. 1;

FIG. 5 is a perspective view of a plural segment base cabinet in accordance with the invention;

FIG. 6 is an exploded view of the cabinet of FIG. 5 illustrating a method of assembly thereof;

FIG. 7 is a perspective view of an upper cabinet in accordance with the invention;

FIG. 8 is an exploded view of the upper cabinet of FIG. 7 illustrating a method of assembly thereof; and

FIG. 9 is a perspective view of the upper cabinet of FIG. 7 illustrating a shelf adjustment feature in accordance with the invention.

### DETAILED DESCRIPTION OF THE INVENTION

In accordance with the invention, a cabinet assembly and method comprises a stacking and interlocking, building block system for building cabinets. Cabinets assemble quickly and securely with no glue, screws or nails, or other fasteners.

Hollow core vertical leg segments are mated with horizontal cross members of varying lengths by aligning the cross member mortise holes with leg core mortise holes and locking and solidifying the components together by use of separate splines running vertically through the aligned mortise holes in the legs and cross members. The leg segments and cross members are stacked from the bottom up on the splines without the use of glues or fasteners. Suspended cabinets or cabinets without countertops are interlocked at the top and bottom of the vertical leg segments through the use of a wood peg or pin through a mortise at the top and bottom of the vertical splines.

Vertical wall panels, doors and shelf holders are retained in dados, rabbets or mortises or holes within the legs and cross members. These cabinet components are inserted and locked in place as the leg and cross members are stacked up on the vertical splines.

In accordance with the invention, virtually any cabinet configuration can be manufactured in accordance with the teachings described herein. The present invention is not directed to any particular cabinet design, but rather the components that enable the cabinet to be assembled quickly and easily as described herein. This application illustrates and describes several variations of cabinet design in accordance with the teachings of the invention. However, the application is not intended to be limited to any of these particular designs.

In accordance with the invention, the various cabinet assemblies include a plurality of wall panels and at least two generally rectangular, horizontal support members to define a parallelepiped configuration. The wall panels may comprise side or end panels, divider walls between cabinet segments, or front or rear panels. The basic cabinet form includes four legs in the form of corner posts selectively supporting the wall panels in a parallelepiped configuration. Each corner post has a rectangular through bore. The horizontal support members include rectangular through bores aligned with the corner post through bores. A rectangular spline is provided, one for each corner post. Each spline is received in the aligned rectangular through bores at one of the corners to maintain the cabinet assembly in assembled relationship.

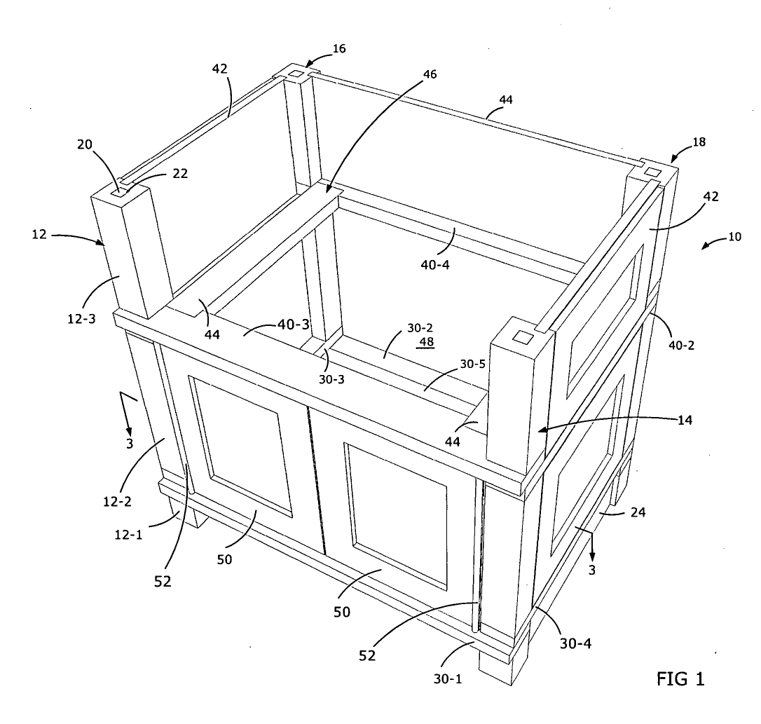

Referring initially to FIGS. 1-3, a cabinet assembly in the form of a base cabinet 10 in accordance with the invention is illustrated. The base cabinet 10 is adapted to support a sink independently of a countertop to be mounted thereon. The particular size of the cabinet components described herein will depend on the overall size of the cabinet 10, as will be apparent.

The base cabinet 10 comprises front corner posts 12 and 14 and rear corner posts 16 and 18. The corner posts are segmented into three segments. For example, the front left corner post 12 comprises a lower segment, or foot, 12-1, a middle segment 12-2 and an upper segment 12-3. The corner post 12 has a rectangular through bore or mortise 20 extending a length of the corner post 12. Particularly, the bore 20 is carried through each of the segments 12-1, 12-2 and 12-3. The other corner posts have a similar bore 20 and are similarly segmented and numbered. In an exemplary embodiment of the invention, each corner post is a 3″ square post having a 1″ square through bore centered in the post. The through bore 20 can be formed by any known means. One exemplary method for forming the bore 20 is to cut a 1″ dado two inches deep down the length of the corner post 20 and glue a 1″ by 1″ filler strip adjacent an outer edge to form the 1″ square through bore. While other shapes could be used, the use of a non-circular through bore is advantageous to prevent turning of the corner posts, as will be apparent.

The base cabinet 10 includes four splines 22, one for each corner post. Each spline 22 is square in cross section and in the exemplary embodiment of the invention, is approximately 31/32″ square to be received in the through bores 20 while providing minimal clearance. The cooperation between the center posts 12, 14, 16 and 18, and splines 22, serve as the basic building blocks for each cabinet assembly in accordance with the invention.

For simplicity herein, other components of the cabinet 10 will be described generally in the order in which the cabinet 10 is assembled.

The lower corner post feet 12-1, 14-1, 16-1 and 18-1 are first placed on a ground support surface. A pair of opposite side baseboards 24 is provided. One side baseboard extends between the feet 12-1 and 16-1. The other side baseboard 24 extends between the feet 14-1 and 18-1. A front baseboard 26 extends between the front feet 12-1 and 14-1. The baseboards 24 and 26 are slidably received in vertical dados in the feet, one of which is identified as 28. With the feet 12-1, 14-1, 16-1 and 18-8 resting on the ground in a rectangular configuration, each of the splines 22 is inserted into the through bore 20 of one of the feet, such as the foot 12-1, and extends upwardly. As will be apparent, each spline 22 has a length just less than a height of the cabinet 10.

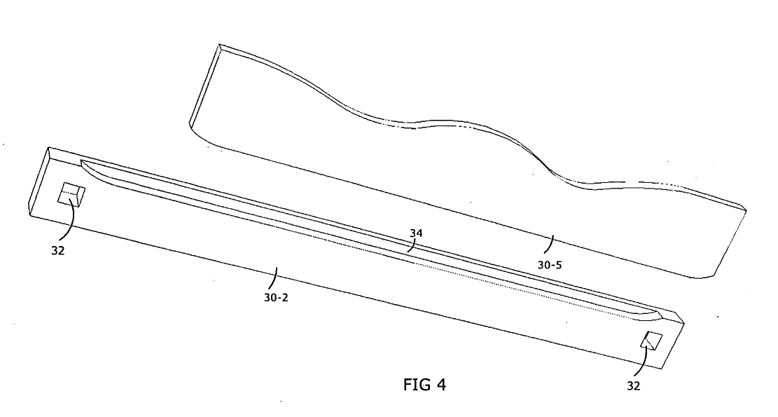

A first horizontal support member 30 comprises a front stretcher 30-1, a rear stretcher 32-2, a left side stretcher 30-3, a right side stretcher 30-4 and a shelf 30-5. The front and rear stretchers 30-1 and 30-2 comprise elongate boards each having a rectangular through bore or mortise 32 of square cross section at each end, see FIG. 4. The mortises may be formed with a conventional square punch and are of the same size as the corner post through bores 22. The front and rear stretchers 30-1 and 30-2 further include a rabbet 34 along facing edges for supporting edges of the shelf 30-5. Thus, the top of the shelf 30-5 is flush with the top of the front and rear stretchers 30-1 and 30-2. The front and rear stretchers 30-1 and 30-2 are assembled to the cabinet by sliding them downwardly over the splines 22. Thereafter, the shelf 30-5 is placed between the front and rear stretchers 30-1 and 30-2. The side stretchers 30-3 and 30-4 similarly include rectangular through bores 32 at front and rear ends thereof. The side stretchers 30-3 and 30-4 are likewise mounted on the splines 22 above the shelf 30-5 and front and rear stretchers 30-1 and 30-2 to maintain the shelf 30-5 in position.

The middle corner post segments 12-2, 14-2, 16-2 and 18-2 are then slid downwardly on each of the splines 22. The left side corner post segments 12-2 and 16-2 include facing dados 34 slidably receiving a side panel 36. Similarly, the right side corner post segments 14-2 and 18-2 include dados 34 slidably receiving a side panel 36.

A second horizontal support member 40 comprises a left side stretcher 4-1, a right side stretcher 40-2, a front stretcher 40-3 and a rear stretcher 40-4. Each includes a rectangular through bore or mortise 42, as above, proximate each end to be slidably received on the splines 22. Particularly, the side stretchers 40-1 and 40-2 are installed first with the front and rear stretchers 40-3 and 40-4 mounted to be received atop ends of the side stretchers 40-1 and 40-2, as shown in FIG. 1. Sink supports 44 are mounted using rabbets at each end received in rabbets of the front and rear stretchers 40-3 and 40-4 to provide a planar surface 46 for supporting a sink (not shown) with a cabinet space 48 therebelow.

The upper corner post segments 12-3, 14-3, 16-3 and 18-3 are then mounted to the splines 22. Side panels 42 and a rear panel 44 are then slidably mounted into corner post dados 46, one of which is identified, to complete the cabinet assembly.

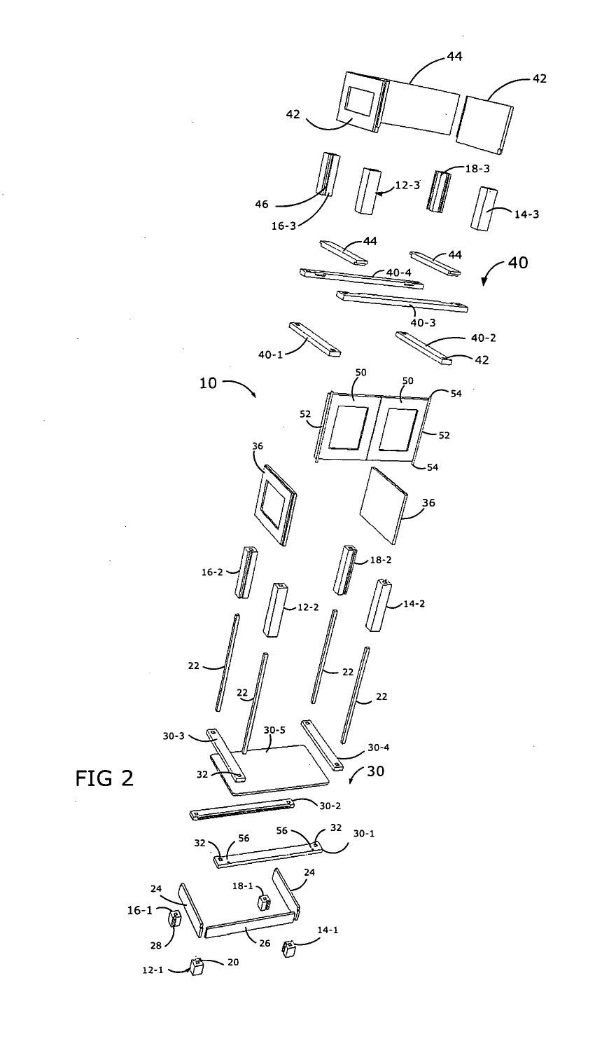

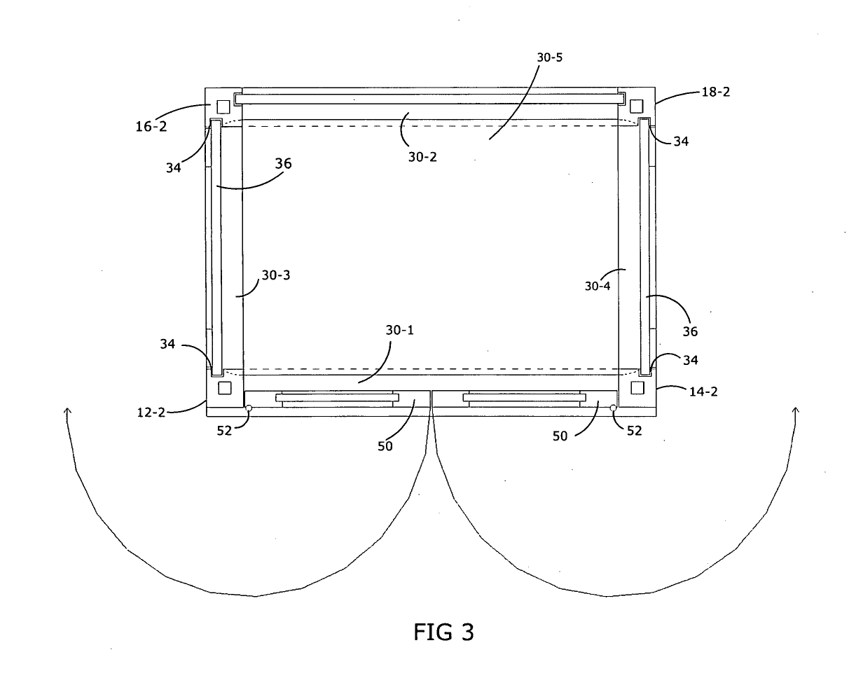

The cabinet space 48 is selectively accessed using doors 50. Each door 50 is of panel construction and includes a dowel rod 52 inset and secured, such as by gluing, along a front side edge, as shown. The dowel rods 52 extend above and below the door panels 50 to define dowel pins 54, see FIG. 2, two of which are numbered, for hingedly mounting the doors 50 to the cabinets 10. Particularly, the lower front stringer 30-1 includes a pair of blind bores 56 near a front edge thereof. Similar blind bores (not shown) face downwardly from the upper front stringer 40-3. The doors are mounted in the cabinet prior to assembly of the upper front stretcher 40-3 by inserting the lowermost dowel pin 54 in the blind bore 56 at one side, and lowering the front stretcher 40-3 so that its corresponding blind bore captures the uppermost dowel pin 54, as will be apparent. The doors can then be hingedly opened and closed, as illustrated schematically in FIG. 3.

As such, the base cabinet 10 is assembled by appropriately positioning the splines 22 using the corner post foot segments 12-1, 14-1, 16-1 and 18-1 and thereafter dropping individual parts downwardly on the appropriate splines to assemble the cabinet without any glue, nails or screws.

Each of the cabinet components can be constructed of any desired material. Typically, each would be constructed of wood, including any of solid wood, plywood, as well as composite materials such as particle board or the like. The various wall panels could be decorative or plain in configuration.

In the illustrated embodiment of the invention, the side edges of the various panels are sized to be received in a ¾″ wide, ½″ deep dados. A panel wall thickness, at least at side edges, on the order of 23/24″ may be used with such a dado size.

In an exemplary embodiment of the invention, the front stretchers 30-1 and 40-3 are about 3¾″ wide with the blind bores 56 having a center located 11/16″ from the front face of the stretcher and 7/16″ from an edge of the adjacent corner post. This allows for full 180° rotation of the door panels 50.

As will be apparent, other dimensions could be used in accordance with the teachings of the invention.

Thus, as described, the base cabinet assembly 10 includes the wall panels as described and the two rectangular horizontal support members 30 and 40 to define a parallelepiped configuration all secured to the elongate segmented corner posts 12, 14, 16 and 18 and maintained in assembled relationship using the splines 22.

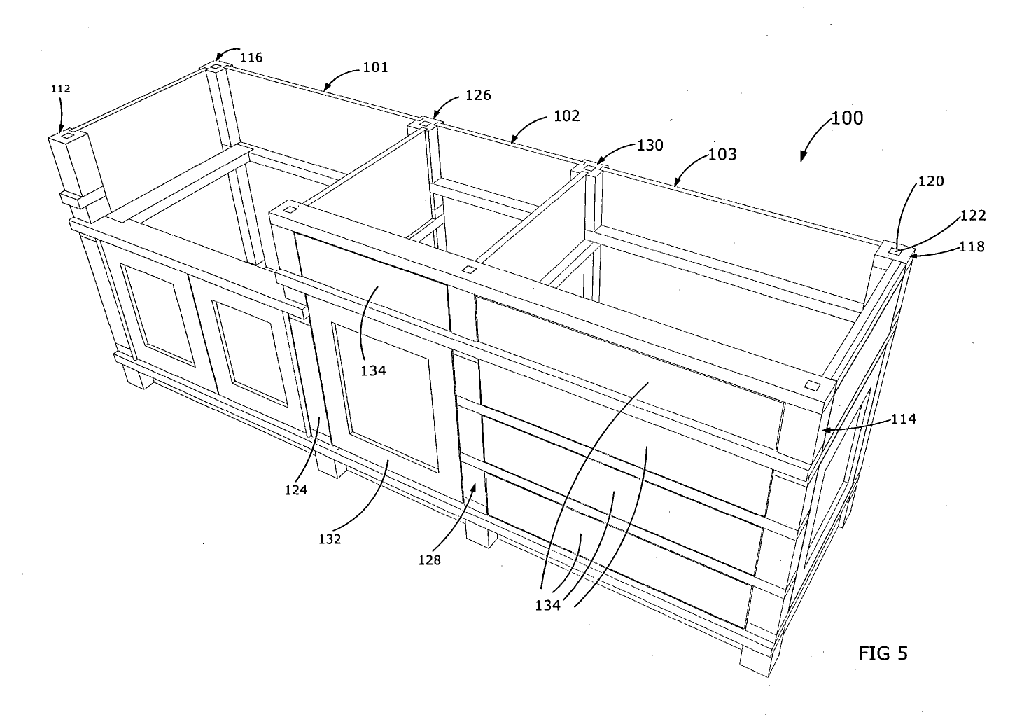

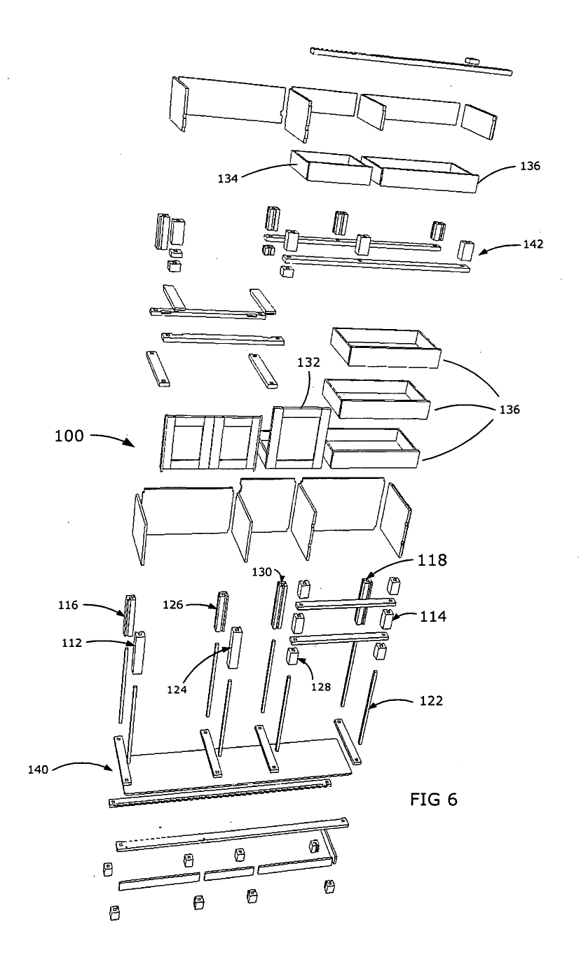

Referring to FIGS. 5 and 6, an alternative base cabinet 100 in accordance with the invention is illustrated.

The base cabinet 100 comprises first, second and third cabinet segments 101, 102 and 103 which define separate cabinet spaces. Conventionally, such cabinet segments 101, 102 and 103 would be manufactured separately and married together at a job site. In accordance with the invention, the cabinet 100 uses four corner posts 112, 114, 116 and 118, as above with the embodiment of FIG. 1. Each includes a rectangular through bore 120 extending therethrough and receiving a spline 122, as with the embodiment of FIG. 1 above. The cabinet assembly 100 includes a plurality of center posts 124, 126, 128 and 130. The center posts 124, 126, 128 and 130 are similar to the corner posts 112, 114, 116 and 118. The center posts 124 and 126 separate the first cabinet segment 101 from the second cabinet segment 102. The center posts 128 and 130 separate the second cabinet segment 102 from the third cabinet segment 103. As such, the center posts 124, 126, 128 and 130 act as legs which are shared between adjacent cabinet segments. Otherwise, the cabinet assembly 100 includes a plurality of wall panels in the form of side panels, including end panels and divider panels, door panels and rear panels, as well as horizontal support members. All of the various components are not described in detail herein as the invention is not intended to be limited to any particular design, but rather intended to illustrate the concepts of the invention for use with the plural cabinet segments.

In the illustrated embodiment of the invention, the first cabinet segment 101 comprises a sink cabinet, similar to the embodiment of FIG. 1. The second cabinet segment 102 comprises a lower door 132 and an upper drawer 134, represented only by a front panel in FIG. 5 to show the interior components. The third cabinet segment 103 includes four drawers 136 which, for illustration purposes, are only illustrated by front panels in FIG. 5. Otherwise the cabinet 100 would be assembled as with the embodiment of FIG. 1 by starting at the bottom and sequentially dropping individual components downwardly on the eight splines 122, as is apparent. As is apparent, the various posts may be segmented differently according to a number of horizontal support members included in each cabinet segment. Also, the horizontal support members may be shared among the cabinet segments. For example, a bottom horizontal support member 140 is shared by all three cabinet segments 101-103. An uppermost horizontal support member 142 is shared by the second and third cabinet segments 102 and 103. Thus, each cabinet segment can have a different number of horizontal support members, based on its intended use.

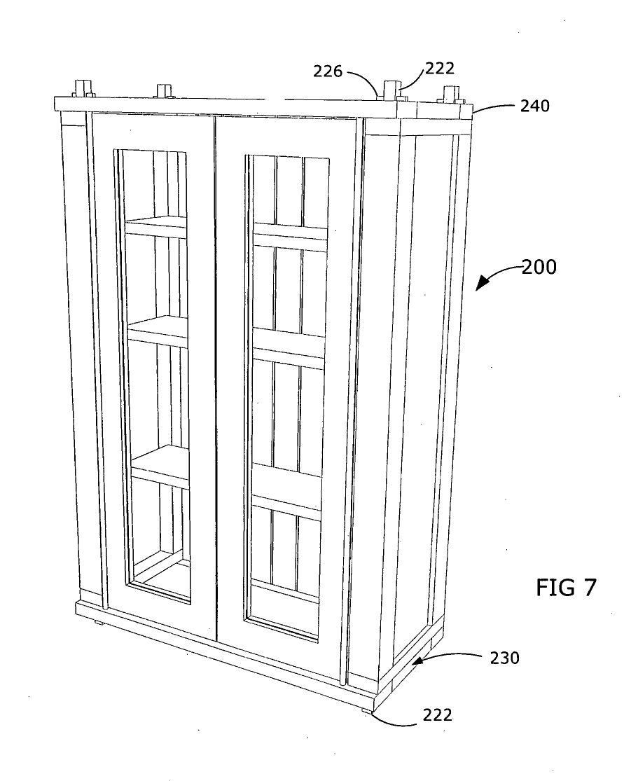

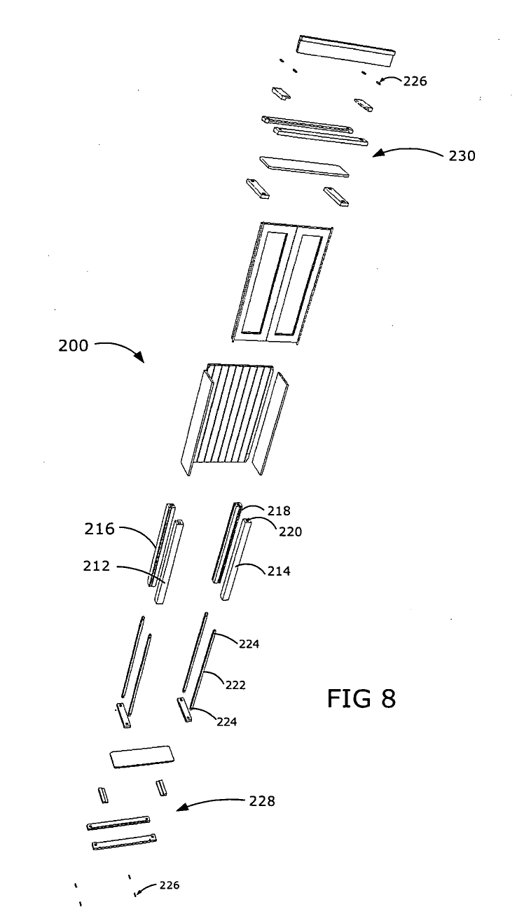

Referring to FIGS. 7 and 8, an upper cabinet assembly 200 in accordance with the invention is illustrated. The upper cabinet assembly 200 is intended to be used as a wall mounted cabinet. As such, the cabinet is not supported on a ground surface. Thus, additional structure is provided for retaining splines within the cabinet corner posts, as described below.

The upper cabinet 200 includes corner posts 212, 214, 216 and 218, similar to those discussed above. Each corner post includes a rectangular through bore 220 for receiving a rectangular spline 222, as above. The splines 222 are similar to the splines 22 and 122, discussed above, except that a transverse through opening 224 is provided at each of opposite ends of each spline 222 for receiving a pin or peg 226 at a top and/or bottom.

Particularly, the upper cabinet 200 would be assembled by first inserting a peg 226 in one of the openings 224 of each spline 222. As is apparent, doing so does not support the splines 222 in a vertical orientation. However, as the various horizontal support members and corner posts are slidably mounted on each spline 22, the structure will become self-standing, using the principles discussed above relative to the embodiment of FIG. 1. Once all of the components have been installed on the splines, then the pegs 226 are inserted in the openings 224 at the top of each spline 222. The spacing between the openings 224 on each spline 222 corresponds to the desired spacing between an uppermost horizontal support member 240 and a bottom of the lower horizontal support member 230 to sandwich all of the various components therebetween to provide a rigid construction. The cabinet 200 can be wall mounted.

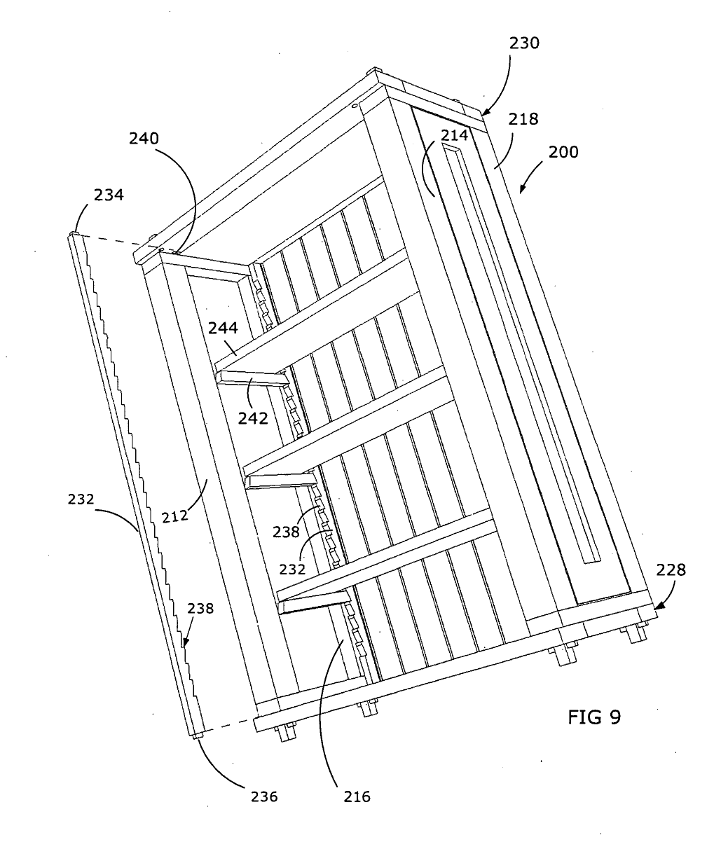

The upper cabinet 200 of FIG. 7 includes a feature, particularly illustrated in FIG. 9 for adjusting shelf positions. The cabinet includes a bottom horizontal support member 228 and a top horizontal support member 230. Four shelf standards 232 are included, two of which are shown, each proximate one of the corner posts 212, 214, 216 and 218. Each shelf standard 238 comprises an elongate board having a top tenon 234 and a bottom tenon 236 and a saw tooth profile 238 along one longitudinal side. The top tenon 234 is received in a mortise 240 opening downwardly from the top horizontal support member 230. The bottom tenon 236 is received in a mortise (not shown) opening upwardly from the bottom horizontal support member 228, as is apparent. Alternatively, the mortise 240 could be sized to receive the ends of the standards 232, eliminating requirement of the tenons 234 and 236.

The standards 232 are installed so that along each cabinet side the saw tooth profiles 238 face one another, as is illustrated in FIG. 9. Shelf supports 242 extend between the standard saw tooth profiles at any desired height to support shelves 244.

With the described construction, the standards 232 are not rigidly secured to side panels and therefore allow for self adjustment due to different amounts of expansion or contraction of individual components over time. While maintained in a desired position, the standards 232 can “float” relative to the cabinet 200 to accommodate such changes.

As can be seen, the principles of assembly described above can be used to build virtually any desired cabinet configuration for a free standing cabinet or a wall mounted cabinet. These structures can be extended vertically as in creating a refrigerator cabinet or a full height pantry cabinet.

As is apparent, the cabinets would not be assembled at the factory prior to shipment to a job site. Instead, the various components of an individual cabinet would be cut at the factory and stacked together in a relatively compact configuration for shipment to the job site. While the weight might be similar to a conventional cabinet design, the space required for shipping each cabinet would be substantially reduced as virtually all space is used by the individual components. The cabinet is then assembled quickly on a job site. The sharing of posts between cabinet segments eliminates the need to screw adjacent cabinets together and likewise eliminate seams. This results in decreased assembly and finishing time. Each cabinet fits together like pieces of a puzzle which should be found intriguing to customers. Also, the use of the posts for carrying weight of the countertops and the like provides increased structural strength over traditional box and frame cabinets for carrying loads from stone countertops to heavy sinks. Leveling shims can be placed between the individual feet and the lowermost horizontal support member as necessary for leveling. Instead of leveling at the floor, the leveling takes place on top of the corner post foot segment and under the lowermost horizontal support member, which protrudes out about ¾″ in front of the foot segment. This protrusion hides the leveling shims. Likewise, the cabinet assembly can be provided to a customer on a do-it-yourself basis for simple and easy assembly by the customer. This can save substantially on costs.

Thus, in accordance with the invention, there is provided a stacking and interlocking, building block system for building cabinets.

I claim:

1. In a cabinet assembly including a plurality of wall panels and at least two generally rectangular horizontal support members to define a parallelepiped configuration, the improvement comprising:
a plurality of elongate corner posts, at least one for each corner of the parallelepiped configuration, the corner posts selectively supporting the wall panels in the parallelepiped configuration, each corner post having a rectangular through bore extending a length of the corner post;
each of said at least two horizontal support members including rectangular through bores aligned with the corner post through bores at each corner of the parallelepiped configuration; and
a plurality of rectangular splines, one for each corner of the parallelepiped configuration, each of the splines being received in the aligned rectangular through bores at one of the corners of the parallelepiped configuration to maintain the cabinet assembly in assembled relationship.

2. The cabinet assembly of claim 1 wherein select ones of the corner posts include an elongate dado receiving edges of the wall panels to support the panels in the parallelepiped configuration.

3. The cabinet assembly of claim 1 wherein the horizontal support members include facing blind bores adjacent a front edge thereof and further comprising a door including a dowel pin extending from above and below the door and receivable in the facing blind bores to hingedly mount the door to the cabinet assembly.

4. The cabinet assembly of claim 3 wherein the door comprise a rectangular panel including a dowel rod secured to a front face of the panel adjacent a side edge, with opposite ends of the dowel rod defining the dowel pins.

5. The cabinet assembly of claim 1 wherein each cabinet post is segmented and a lower segment of each corner post is positioned below a lowermost of the horizontal support members to define a foot for resting on a support surface.

6. The cabinet assembly of claim 1 further comprising a plurality of pins each extending through a transverse opening at one of a top or bottom end of each spline.

7. The cabinet assembly of claim 1 wherein at least one of the horizontal support members comprises a front stretcher and a rear stretcher and the rectangular through bores are located at ends of the stretchers.

8. The cabinet assembly of claim 7 further comprising a shelf receivable on the front and rear stretcher of the at least one of the horizontal support members.

9. The cabinet assembly of claim 8 wherein the at least one of the horizontal support members further comprises opposite side stretchers each having rectangular through bores located at ends of the side stretchers for receiving the splines, the side stretchers resting atop the shelf and front and rear stretchers to retain the shelf in place.

10. The cabinet assembly of claim 1 further comprising a plurality of elongate center posts, the center posts selectively supporting wall panels in vertical plains between opposite ends of the parallelepiped configuration, each center post having a rectangular through bore extending a length of the center post and aligned with corresponding aligned rectangular through bores in the horizontal support members for receiving a rectangular spline to maintain the cabinet assembly in assembled relationship to define plural cabinet segments sharing the center posts.

11. The cabinet assembly of claim 1 further comprising shelf standards received in facing mortises in the rectangular horizontal support members.

12. The method of assembling a cabinet including a plurality of wall panels and at least two generally rectangular horizontal support members to define a parallelepiped configuration, comprising:
providing a plurality of elongate corner posts, at least one for each corner of the parallelepiped configuration, the corner posts selectively supporting the wall panels in the parallelepiped configuration, each corner post having a rectangular through bore extending a length of the corner post;
providing rectangular through bores in each of said at least two horizontal support members aligned with the corner post through bores at each corner of the parallelepiped configuration;
providing a plurality of rectangular splines, one for each corner of the parallelepiped configuration; and
sequentially mounting the corner posts and the horizontal support members to the rectangular splines so that each of the splines is received in the aligned rectangular through bores at one of the corners of the parallelepiped configuration to maintain the cabinet assembly in assembled relationship.

13. The method of assembling a cabinet of claim 12 wherein select ones of the corner posts include an elongate dado receiving edges in the wall panels to support the panels in the parallelepiped configuration.

14. The method of assembling a cabinet of claim 12 wherein the horizontal support members include facing blind bores adjacent a front edge thereof and further comprising providing a door including a dowel pin extending from above and below the door and receivable in the facing blind bores to hingedly mount the door to the cabinet assembly.

15. The method of assembling a cabinet of claim 14 wherein the door comprise a rectangular panel including a dowel rod secured to a front face of the panel adjacent a side edge, with opposite ends of the dowel rod defining the dowel pins.

16. The method of assembling a cabinet of claim 12 wherein each cabinet post is segmented and a lower segment of each corner post is positioned below a lowermost of the horizontal support members to define a foot for resting on a support surface.

17. The method of assembling a cabinet of claim 12 further comprising providing a plurality of pins and inserting each pin through a transverse opening at one of a top or bottom end of each spline.

18. The method of assembling a cabinet of claim 12 wherein at least one of the horizontal support members comprises a front stretcher and a rear stretcher and the rectangular through bores are located at ends of the stretchers.

19. The method of assembling a cabinet of claim 18 further comprising providing a shelf receivable on the front and rear stretcher of the at least one of the horizontal support members.

20. The method of assembling a cabinet of claim 19 wherein the at least one of the horizontal support members further comprises opposite side stretchers each having rectangular through bores located at ends of the side stretchers for receiving the splines, the side stretchers resting atop the shelf and front and rear stretchers to retain the shelf in place.

21. The method of assembling a cabinet of claim 12 further comprising providing a plurality of elongate center posts, the center posts selectively supporting wall panels in vertical plains between opposite ends of the parallelepiped configuration, each center post having a rectangular through bore extending a length of the center post and aligned with corresponding aligned rectangular through bores in the horizontal support members for receiving a rectangular spline to maintain the cabinet assembly in assembled relationship to define plural cabinet segments sharing the center posts.

22. The method of assembling a cabinet of claim 12 further comprising providing shelf standards received in facing mortises in the rectangular horizontal support members.
